(19) United States
(12) Patent Application Publication
(10) Pub. No.: US 2026/0328477 A1
(43) Pub. Date: Oct. 22, 2026

(54) MOLTEN METAL FURNACE

(71) Applicant: TOUNETSU CO., LTD., Shizuoka (JP)

(72) Inventors: Kiyata MOCHIZUKI, Shizuoka (JP); Tsukasa SHIMOTO, Shizuoka (JP)

(73) Assignee: TOUNETSU CO., LTD., Shizuoka (JP)

(21) Appl. No.: 19/113,312

(22) PCT Filed: Nov. 29, 2022
(86) PCT No.: PCT/JP2022/043863

§ 371 Date: Mar. 19, 2025

(30) Foreign Application Priority Data
Oct. 25, 2022 (JP) 2022-170778

(51) Int. Cl. F27B 3/20; F27B 3/16

(52) U.S. Cl. CPC F27B 3/20; F27B 3/16; F27B 2003/165

(57) ABSTRACT

A molten metal furnace which shortens the time required for melting a metal material in molten metal.

The molten metal furnace includes a metal-melting chamber for accommodating molten metal therein and performing at least one of melting a metal material in flowing melt of molten metal and raising temperature of molten metal, wherein an elongate molten-metal-heating unit for heating the molten metal is provided inside the metal-melting chamber, wherein the molten-metal-heating unit is provided extending from a side wall toward the lower part of the metal-melting chamber, and wherein the bottom face of the metal-melting chamber located below the molten-metal-heating unit is slanted along the same direction as that of the molten-metal-heating unit with a predetermined gap kept therebetween.

### CROSS-REFERENCE TO RELATED APPLICATIONS

This application is the U.S. national stage application of International Application No. PCT/JP2022/043863, filed Nov. 29, 2022, which international application was published on May 2, 2024, as International Publication WO 2024/089904 in the Japanese language. The International Application claims priority to Japanese Patent Application No. 2022-170778, filed Oct. 25, 2022. The international application and Japanese application are both incorporated herein by reference, in their entireties.

### FIELD OF THE INVENTION

The present invention relates to a molten metal furnace for melting metal, such as non-ferrous metal, like aluminum or aluminum alloys, or raising temperature of metal that has been molten (referred to as “molten metal” hereinbelow).

### BACKGROUND OF THE INVENTION

Conventional melting of metal, such as non-ferrous metal, like aluminum or aluminum alloys, or conventional raising of molten metal temperature is predominantly performed by introducing, in a melting furnace, ingots, return scrap, scrap material (including, e.g., briquette material and machined chips, the same applies hereinbelow), and the like, and by using heaters or burners, melting the same in the melt of the molten material, or raising temperature of the molten metal.

For example, Patent Publication 1 discloses a melting furnace for melting metal material into molten material by heat of combustion gas (flame) from burners, and raising temperature of the molten material.

### PRIOR ART PUBLICATION

### Patent Publication

Patent Publication 1: JP 6629477 B

### BRIEF SUMMARY OF THE INVENTION

### Problems to be Solved by the Invention

According to such conventional methods, heat from heaters or burners was not always transferred sufficiently to the metal material, such as ingots, return scrap, or scrap material, so that melting the metal material or raising the molten metal temperature is disadvantageously time-consuming.

It is therefore an object of the present invention to shorten the time required for melting metal material in a molten metal without being exposed to air (referred to also as “submerged non-oxidizing melting” hereinbelow).

### Means for Solving the Problem

Aspects of the means for solving the above problem are as follows:

### First Aspect

A molten metal furnace including a metal-melting chamber for accommodating molten metal therein and performing at least one of melting metal material in flowing melt of molten metal and raising temperature of molten metal,

wherein an elongate molten-metal-heating unit for heating the molten metal is provided inside the metal-melting chamber,

wherein the molten-metal-heating unit is provided extending from a side wall toward a lower part of the metal-melting chamber, and

wherein a bottom face of the metal-melting chamber located below the molten-metal-heating unit is slanted along a same direction as that of the molten-metal-heating unit with a predetermined gap kept therebetween.

### Function and Effect

According to the molten metal furnace of the first aspect, the flow speed of the molten metal flowing through the space of the predetermined gap kept between the molten-metal-heating unit and the bottom face of the metal-melting chamber is higher, so that the heat-transfer efficiency from the molten-metal-heating unit to the molten metal may be increased. As a result, melting time of the metal material in the molten metal may be shortened.

A metal-melting chamber of a generally cubic or cuboid shape wherein a conventional molten-metal-heating unit is arranged vertically, necessarily had a height which was made higher to a certain extent in order to accommodate the molten-metal-heating unit. However, when the metal-melting chamber, which has a larger height, is placed adjacent to an existing facility (e.g., a hot-water supply apparatus for a die-casting machine, which apparatus has a maximum height of about 1200 mm, the same is applied hereinbelow), the height of the metal-melting chamber is often larger than that of the existing facility. With such a difference in height between the metal-melting chamber and the existing facility, the operation efficiency of the existing facility could be lower.

For the purpose of avoiding such inconveniences, it is conceivable to make the height of the metal-melting chamber smaller and the width larger to make the volume of the metal-melting chamber comparable to that of the conventional metal-melting chamber, and to arrange vertically a molten-metal-heating unit of a smaller length and a larger diameter (heating capacity comparable to that of the conventional molten-metal-heating unit requires a larger diameter) in the metal-melting chamber. However, such a molten-metal-heating unit should be custom-made, which leads to a significantly higher cost (about ten times) compared to the conventional molten-metal-heating unit, and disadvantageously increased initial cost.

On the other hand, a metal-melting chamber wherein a conventional molten-metal-heating unit is arranged horizontally, necessarily has a larger width, which leads to a larger bottom face area of the metal-melting chamber. As the melting of metal proceeds, unnecessary matter accumulates on the bottom face of the metal-melting chamber. With a larger bottom face area of the metal-melting chamber, collection of the unnecessary matter scattered all over the bottom face of the metal-melting chamber inconveniently takes a lot of labor.

In order to resolve such inconveniences, according to the first aspect, the molten-metal-heating unit is arranged at a slant, i.e., provided extending from a side wall toward the lower part of the metal-melting chamber. With such a configuration, the height of the metal-melting chamber may be made lower compared to that of the conventional metal-melting chamber wherein the molten-metal-heating unit is arranged vertically. In this way, the disadvantage of the lowered operation efficiency of the existing facility may be avoided. Further, the bottom face area of the metal-melting chamber may be made smaller compared to that of the conventional metal-melting chamber wherein the molten-metal-heating unit is arranged horizontally, so that the collection of the unnecessary matter accumulated on the bottom face of the metal-melting chamber may be made less laborious.

In addition, according to the first aspect, the bottom face of the metal-melting chamber is slanted along the same direction as that of the molten-metal-heating unit with a predetermined gap kept therebetween. In this way, with the bottom face of the metal-melting chamber at a slant, the unnecessary matter gathers in the lowest area on the bottom face of the metal-melting chamber, so that the collection of the unnecessary matter accumulated on the bottom face of the metal-melting chamber may be made less laborious.

Further, with the bottom face of the metal-melting chamber at a slant, the volume of the metal-melting chamber may be reduced compared to that of the conventional metal-melting chamber of a generally cubic or cuboid shape, which in turn reduces the amount of the molten metal accommodated in the metal-melting chamber. In this way, with the same output of the molten-metal-heating unit as the conventional one, the heat from the molten-metal-heating unit for the reduced amount of molten metal may be applied to raising of the molten metal temperature, which results in shortening of the time required for raising the motel metal temperature.

### Second Aspect

The molten metal furnace according to the first aspect, wherein the bottom face of the metal-melting chamber has:

a sloping bottom face section located below and slanted approximately parallel to the molten-metal-heating unit, and

a laterally-extending bottom face section extending laterally from a lower end of the sloping bottom face section, and

wherein an unnecessary-matter-accumulated area in which unnecessary matter contained in the molten metal is accumulated is provided on the laterally-extending bottom face section.

### Function and Effect

The conventional molten metal furnace also had the following problems. That is, during introduction of ingots, return scrap, scrap material, or the like, into the molten metal furnace, the molten metal in the molten metal furnace is brought into contact with external air. The air filling the space between the lid of the metal-melting chamber and the molten metal is also brought into contact with the molten metal. When the molten metal is brought into contact with air in this way, oxides are generated in the molten metal. Further, since ingots and the like contain heavy metal, such as copper, iron, and zinc, melting of ingots or the like results in by-products. Such oxides and by-products are scattered and gradually accumulated on the bottom face of the metal-melting chamber with the lapse of time, and collection of such oxides and by-products using a ladle or the like disadvantageously takes a lot of labor.

Unnecessary matter contained in the molten metal (referring to the oxides and the by-products mentioned above, collectively referred to as the unnecessary matter hereinbelow) is gradually accumulated on the bottom face of the metal-melting chamber by gravity with the lapse of time. Here, by tilting part of the bottom face of the metal-melting chamber as in the second embodiment, the unnecessary matter may be accumulated on the laterally-extending bottom face section extending laterally from the lower end of the sloping bottom face section. That is, the unnecessary matter will not be scattered all over the bottom face of the metal-melting chamber, but naturally gathers onto the laterally-extending bottom face section. Accordingly, the unnecessary matter may simply be collected using a ladle or the like by scooping out the unnecessary matter accumulated on the laterally-extending bottom face section, which results in increased collection efficiency of the unnecessary matter.

### Third Aspect

The molten metal furnace according to the first aspect,

wherein a lid covering the metal-melting chamber is provided in an upper part of the metal-melting chamber,

wherein the lid of the metal-melting chamber located above the molten-metal-heating unit is slanted along a same direction as that of the molten-metal-heating unit with a predetermined gap kept therebetween.

### Function and Effect

According to the molten-metal furnace of the third aspect, the flow speed of the molten metal flowing through the space between the molten-metal-heating unit and the lid of the metal-melting chamber is higher, so that the heat-transfer efficiency from the molten-metal-heating unit to the molten metal may be increased. As a result, melting time of the metal material in the molten metal may still be shortened.

Further, as the lid of the metal-melting chamber is slanted along the same direction as that of the molten-metal-heating unit, the volume of the metal-melting chamber is reduced compared to that of the conventional metal-melting chamber of a generally cubic or cuboid shape, which in turn reduces the amount of the molten metal accommodated in the metal-melting chamber. In this way, with the same output of the molten-metal-heating unit as the conventional one, the heat from the molten-metal-heating unit for the reduced amount of molten metal may be applied to raising of the molten metal temperature, which results in shortening of the time required for raising the molten metal temperature.

### Fourth Aspect

A molten metal furnace including a metal-melting chamber for accommodating molten metal therein and performing at least one of melting metal material in flowing melt of molten metal and raising temperature of molten metal,

wherein an elongate molten metal-heating unit for heating the molten metal is provided inside the metal-melting chamber,

wherein the molten-metal-heating unit is provided extending from a side wall toward a lower part of the metal-melting chamber,

wherein a lid covering the metal-melting chamber is provided in an upper part of the metal-melting chamber, and

wherein the lid of the metal-melting chamber located above the molten-metal-heating unit is slanted along a same direction as that of the molten-metal-heating unit with a predetermined gap kept therebetween.

### Function and Effect

According to the molten metal furnace of the fourth aspect, the flow speed of the molten metal flowing through the space of the predetermined gap kept between the molten-metal-heating unit and the lid of the metal-melting chamber is higher, so that the heat-transfer efficiency from the molten-metal-heating unit to the molten metal may be increased. As a result, melting time of the metal material in the molten metal may be shortened.

Further, as the lid of the metal-melting chamber is slanted along the same direction as that of the molten-metal-heating unit, the volume of the metal-melting chamber is reduced compared to that of the conventional metal-melting chamber of a generally cubic or cuboid shape, which in turn reduces the amount of the molten metal accommodated in the metal-melting chamber. In this way, with the same output of the molten-metal-heating unit as the conventional one, the heat from the molten-metal-heating unit for the reduced amount of molten metal may be applied to raising of the molten metal temperature, which results in shortening of the time required for raising the molten metal temperature.

### Effect of the Invention

According to the present invention, the time required for melting metal material in molten metal may be shortened.

### BRIEF DESCRIPTION OF THE DRAWINGS

FIG. 1 is a schematic plan view of a molten metal furnace according to the first embodiment.

FIG. 2 is a sectional view of a metal melting chamber, taken along lines Z1-Z1 in FIG. 1.

FIG. 3 is a schematic sectional view of an example of flow-generating apparatus and a flow-generating chamber.

FIG. 4 is a schematic plan view of a molten metal furnace according to the second embodiment.

FIG. 5 is a sectional view of a metal melting chamber, taken along lines Z2-Z2 in FIG. 4.

FIG. 6 is a schematic plan view of a molten metal furnace according to the third embodiment.

FIG. 7 is a sectional view of a metal melting chamber according to a comparative example.

### DETAILED DESCRIPTION OF THE INVENTION

Embodiments of the present invention will now be discussed below.

Preferred embodiments of molten metal furnace 1 according to the present invention are discussed below with reference to the drawings. The description below and the drawings merely show some embodiments of the present invention, which should not be interpreted as limiting the invention.

### First Embodiment

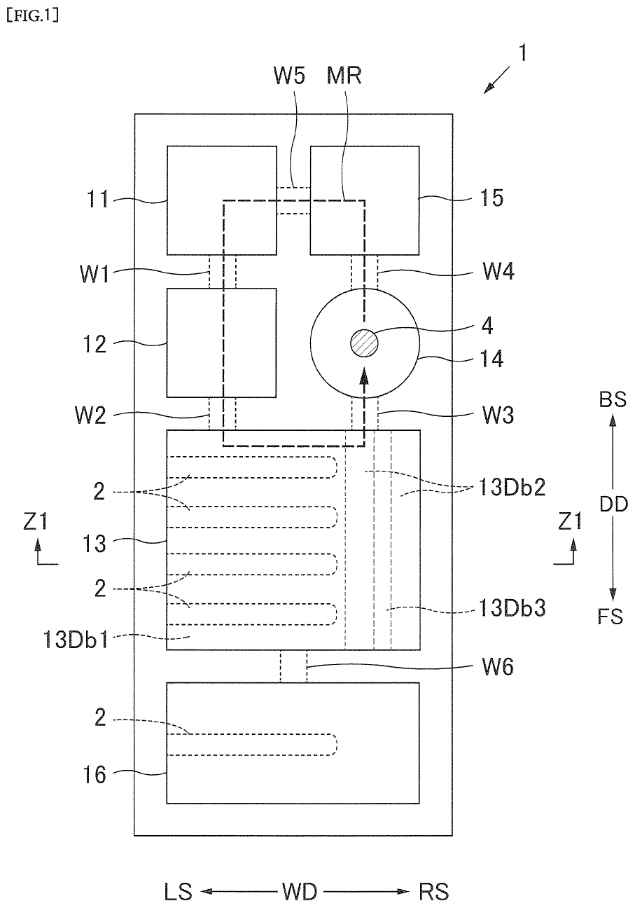

FIG. 1 shows a first embodiment of molten metal furnace 1 according to the present invention. The molten metal furnace 1 includes ingot-introduction chamber 11 into which ingots are introduced, return-scrap-introduction chamber 12 into which return scrap is introduced, metal-melting chamber 13 for performing at least one of melting metal material in flowing melt of molten metal MM and raising temperature of molten metal MM, flow-generating chamber 14 equipped with flow-generating apparatus 4 for causing molten metal MM to flow, slag-removing chamber 15 wherein molten metal slag is removed, and melt-tapping chamber 16 from which molten metal MM prepared by melting metal material is tapped out.

In the metal-melting chamber 13, ingots that have not been molten completely in the flowing molten metal MM in the ingot-introduction chamber 11 or the return-scrap-introduction chamber 12, and return scrap that has not been molten completely in the flowing molten metal MM in the return-scrap chamber 12, are molten.

### Flow of Molten Metal MM

The ingot-introduction chamber 11, the return-scrap-introduction chamber 12, the metal-melting chamber 14, the flow-generating chamber 14, and the slag-removing chamber 15 are arranged annularly in this order. Flow of the molten metal MM will now be discussed in detail below.

First, ingots are introduced into molten metal MM in the ingot-introduction chamber 11, and the molten metal MM containing the ingots molten in the flowing molten metal MM in the ingot-introduction chamber 11 and the ingots not completely molten in the ingot-introduction chamber 11 passes through first transfer line W1 into the return-scrap-introduction chamber 12, wherein fresh return scrap is introduced into the molten metal MM. The return scrap is unnecessary portion remaining from a casting process, and thus has various shapes. The return scrap, before being introduced into the return-scrap-introduction chamber 12, is preliminarily crushed in a breaker, and the crushed return scrap is conveyed on a conveyor into the return-scrap-introduction chamber 12. The molten metal MM containing the return scrap molten in the flowing molten metal MM in the return-scrap-introduction chamber 12 and the return scrap not completely molten in the return-scrap-introduction chamber 12 passes through second transfer line W2 into the metal-melting chamber 13.

In the metal-melting chamber 13, the molten metal MM is heated by molten-metal-heating unit 2 (e.g., heaters) to perform at least one of (1) melting at least either of the ingots or the return scrap not completely molten in the molten metal MM, and (2) raising temperature of the molten metal MM.

Part of the molten metal MM in the metal-melting chamber 13 passes through third transfer line W3 into the flow-generating chamber 14, wherein a circulating flow of the molten metal MM is generated by the flow generating apparatus 4, through the ingot-introduction chamber 11, the return-scrap-introduction chamber 12, the metal-melting chamber 13, the flow-generating chamber 14, the slag-removing chamber 15, the ingot-introduction chamber 11, and so on. The molten metal MM in the flow-generating chamber 14 passes through fourth transfer line W4 into the slag-removing chamber 15.

In this way, it is preferred to circulate the molten metal MM among the ingot-introduction chamber 11, the return-scrap-introduction chamber 12, the metal-melting chamber 13, the flow-generating chamber 14, and the slag-removing chamber 15. The molten metal MM is circulated for the following purpose.

That is, ingots and return scrap (referred to as objects hereinbelow) are introduced as are in the form of solids into the melt of the molten metal MM, wherein the objects per se are under non-oxidizing conditions not in contact with atmosphere. The molten metal MM surrounds the objects entirely, so that the heat of the molten metal MM is uniformly transferred to the objects, which start melting. Here, the temperature of the molten metal MM surrounding (about) the objects is lowered, resulting in uneven temperature distribution over the molten metal MM. The molten metal MM is circulated for the purpose of resolving this uneven temperature distribution to maintain a uniform temperature.

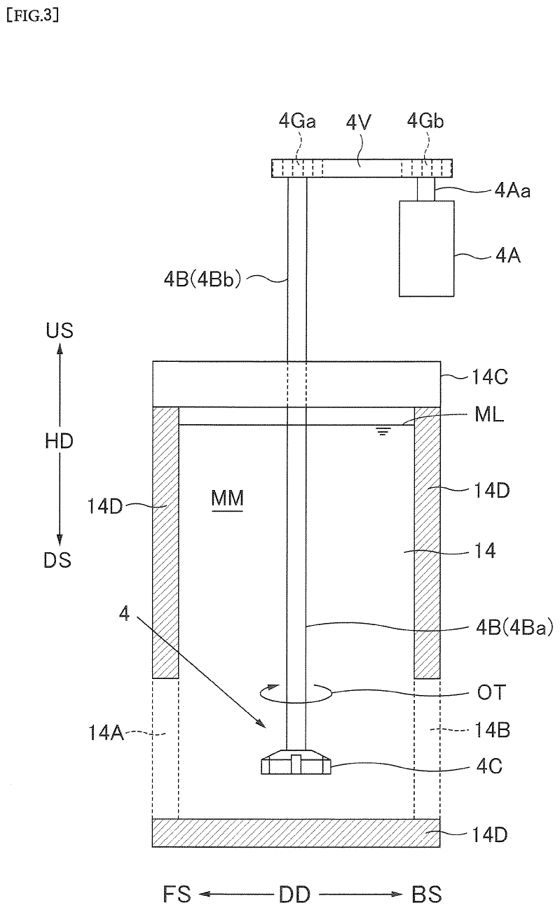

Now, structure of the flow-generating apparatus 4 is discussed in detail. FIG. 3 schematically shows an example of the flow-generating apparatus 4. This flow-generating apparatus 4 has motor 4A located outside the flow-generating chamber 14, rotary shaft 4B extending from above (US) the flow-generating chamber 14 downwards (DS) and rotated by the motor 4A, and an impeller 4C provided at the lower end of the rotary shaft 4B and positioned in the lower part of the flow-generating chamber 14. The rotary shaft 4B has a driven shaft 4Ba positioned inside the flow-generating chamber 14 and an output shaft 4Bb positioned outside and above the flow-generating chamber 14. Another rotary shaft 4Aa is provided at the top of the motor 4A. Gears 4Ga and 4Gb are attached to the output shaft 4Bb and the rotary shaft 4Aa, respectively, and coupled with belt 4V. With such a structure, the motor 4A rotates the impeller 4C. FIG. 3 illustrates the impeller 4C rotating clockwise, but where the flow of the molten metal MM is desired to be in the reverse direction, the rotation direction OT of the impeller 4C may be reversed (counterclockwise).

A supply port 14A of the molten metal MM passing from the metal-melting chamber 13 into the flow-generating chamber 14 is provided through the side wall of the flow-generating chamber 14 in its lower part on one side thereof (on the left in the figure), and a discharge port 14B of the molten metal MM passing from the flow-generating chamber 14 into the slag-removing chamber 15 is provided through the side wall of the flow-generating chamber 14 in its lower part on the other side thereof (on the right in the figure). On the flow-generating chamber 14 is provided lid 14C, so that the molten metal MM in the flow-generating chamber 14 will not spill out. Though not shown in the embodiment of FIG. 3, heat insulator 20 may preferably be provided around vessel 14D of the flow-generating chamber 14 for keeping the molten metal MM from decreasing in temperature.

The structures of the flow-generating apparatus 4 and the flow-generating chamber 14 shown in FIG. 3 are mere examples, and may be modified suitably. For example, the motor 4A may directly be attached to the output shaft 4Bb, the shape of the impeller 4C is changed to a screw or propeller shape (note that the impeller 4C shown in FIG. 3 is in a paddle shape), or the impeller 4C is omitted and gas, such as nitrogen, is blown in through a nozzle. Further, it is preferred to position the impeller 4C, the supply port 14A, and the discharge port 14B on the same level for causing efficient flow of the molten metal MM, and this level may be shifted upwards (US) from the position shown in FIG. 3.

Further, the interior space of the vessel 14D of the flow-generating chamber 14 in FIG. 3, in which the flow of the molten metal MM generated by the impeller 4C becomes vortex, is preferably generally cylindrical, which does not disturb the vortex.

The molten metal MM discharged from the flow-generating chamber 14 as discussed is passed into the slag-removing chamber 15, wherein slag (protective oxide-coating generated on the melt surface of the molten metal MM or oxides suspended in the molten metal MM) in the molten metal MM is scooped out with a ladle or the like to remove. Alternatively, flux in powder form for use in melting metal is spread over the molten metal MM in advance to cause the flux to adsorb the slag to remove. The molten metal MM deprived of the slag passes through fifth transfer line W5 into the ingot-introduction chamber 11. The subsequent flow of the molten metal MM returned to the ingot-introduction chamber 11 is the same as discussed above, so that further discussion is omitted.

Part of the molten metal MM in the metal-melting chamber 13, in which ingots and return scrap are dissolved, passes through sixth transfer line W6 into the melt-tapping chamber 16. Part of the molten metal MM in the melt-tapping chamber 16 is tapped out into casting apparatus or a diecasting-machine in a subsequent stage at an appropriate time. In order to keep the temperature of the molten metal MM in the melt-tapping chamber 16 from lowering, the melt-tapping chamber 16 may preferably be provided inside thereof with molten-metal-heating unit 2, such as heaters.

As discussed above, the molten metal MM flows through the ingot-introduction chamber 11, the return-scrap-introduction chamber 12, the metal-melting chamber 13, the flow-generating chamber 14, the slag-removing chamber 15, and the melt-tapping chamber 16. As these chambers are interconnected, the melt level ML in the ingot-introduction chamber 11, the return-scrap-introduction chamber 12, the metal-melting chamber 13, the flow-generating chamber 14, the slag-removing chamber 15, and the melt-tapping chamber 16 remains constant without fluctuation, even if ingots and return scrap are introduced and part of the molten metal MM is tapped out.

The direction MR of the circulating flow of the molten metal MM is discussed above as counterclockwise as seen in FIG. 1, but may alternatively be clockwise. That is, the molten metal MM may flow through the ingot-introduction chamber 11, the slag-removing chamber 15, the flow-generating chamber 14, the metal-melting chamber 13, the return-scrap-introduction chamber 12, the ingot-introduction chamber 11, and so on. However, for preparing for the tapping out of the molten metal MM, it is preferred to promptly melt the ingots not completely molten in the ingot-introduction chamber 11 among those introduced therein and the return scrap not completely molten in the return-scrap-introduction chamber 12 among those introduced therein, under the non-oxidizing conditions in the melt of the molten metal MM. In this light, it is preferred for the ingots and the return scrap to promptly reach the metal-melting chamber 13, so that counterclockwise flow of the molten metal MM as shown in FIG. 1 is preferred. Note that the direction of flow of the molten metal MM may be changed by the flow-generating apparatus 4, for example, by reversing the rotation of the impeller 4C.

### Metal-Melting Chamber 13

Next, the metal-melting chamber 13 will now be discussed in detail. The metal-melting chamber 13 is the interior space of vessel 13D for the metal-melting chamber, and contains the molten metal MM therein. The molten metal MM contains therein the ingots not completely molten in the ingot-introduction chamber 11 and the return scrap not completely molten in the return-scrap-introduction chamber 12. Before tapping out the molten metal MM from the melt-tapping chamber 16, it is necessary to melt the ingots not completely molten in the ingot-introduction chamber 11 and the return scrap not completely molten in the return-scrap-introduction chamber 12. For this purpose, inside the metal-melting chamber 13 is provided molten-metal-heating unit 2 for heating the molten metal MM to melt the ingots not completely molten in the ingot-introduction chamber 11 and the return scrap not completely molten in the return-scrap-introduction chamber 12.

The molten-metal-heating unit 2 is not particularly limited, and may preferably be those do not disturb the flow of the molten metal MM in the metal-melting chamber 13, and elongate cylindrical heaters are preferred rather than plate-shaped heaters. Specifically, heaters in a tubular shape, such as tube burners or tube heaters, are preferred.

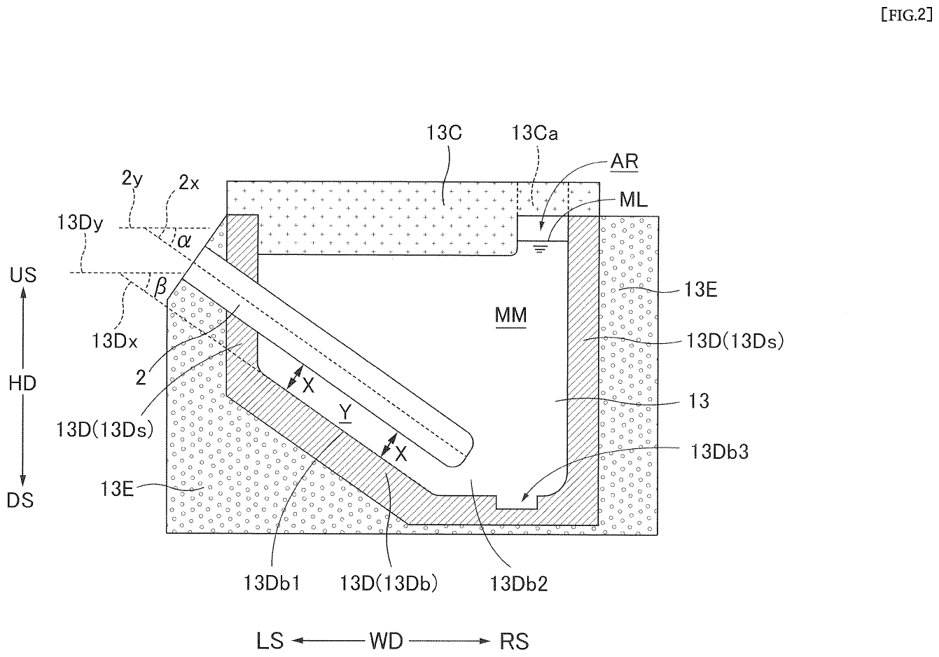

The proximal end of a molten-metal-heating unit 2 is disposed through a side wall of the metal-melting chamber 13. In the embodiment illustrated in FIG. 2, the proximal end of a molten-metal-heating unit 2 is disposed through the vessel 13D for the metal-melting chamber and heat insulator 13E arranged on the exterior of the vessel 13D for the metal-melting chamber, in the upper part of side wall 13De (side wall on the left in the figure) of the vessel 13D for the metal-melting chamber and the upper part of a side wall (side wall on the left in the figure) of the heat insulator 13E. The molten-metal-heating unit 2 extends from the side wall toward the lower part of the metal-melting chamber 13. In the embodiment illustrated in FIG. 2, the molten-metal-heating unit 2 is provided extending from the upper part of the side wall 13Ds (side wall on the left in the figure) toward bottom 13Db on the opposite side (the bottom section on the right in the figure), of the vessel 13D for the metal-melting chamber. In other words, the molten-metal-heating unit 2 is provided extending from the upper part of the side wall 13Ds (side wall on the left in the figure) of the vessel 13D for the metal-melting chamber toward the lower part of the side wall 13Ds on the opposite side (side wall on the right in the figure).

The tilt angle of the molten-metal-heating unit 2 may arbitrarily be decided, and the angle α of depression between the axis 2x of the molten-metal-heating unit 2 and the imaginary horizontal line 2y is preferably 20 to 45 degrees, more preferably 30 to 40 degrees.

With the angle α being smaller than 20 degrees, the height of the metal-melting chamber 13 may be made smaller, which may avoid the above-discussed disadvantage of deteriorating operation efficiency of the existing facility.

On the other hand, with the height of the metal-melting chamber 13 being too small, the heights of the return-scrap-introduction chamber 12 and the flow-generating chamber 14 may need to be adjusted. If the heights of the return-scrap-introduction chamber 12 and the flow-generating chamber 14 are not adjusted, the heights of each chamber 12, 13, and 14 differ significantly, which causes distortion of the transfer lines respectively connecting the return-scrap-introduction chamber 12 and the flow-generating chamber 14 to the metal-melting chamber 13 (the second transfer line W2 and the third transfer line W3), resulting in difficulties in flow of the molten metal MM.

Further, with the height of the metal-melting chamber 13 being too much smaller than that of the return-scrap-introduction chamber 12 or the flow-generating chamber 14 (e.g., with the height of the metal-melting chamber 13 being too much smaller than the height of the return-scrap-introduction chamber 12), too much molten metal MM may flow into the metal-melting chamber 13 to overflow.

In view of the above, it is not preferred to make the height of the metal-melting chamber 13 too small, and a certain height is required. In this way, there is originally no demand for too small an angle α of the molten-metal-heating unit 2.

On the other hand, with a smaller angle α of the molten-metal-heating unit 2, the direction of its extension is closer to the horizontal, which requires a larger width of the metal-melting chamber 13 for accommodating the molten-metal-heating unit 2. As a result, disadvantageously, a larger space is required for placing the metal-melting chamber 13. Further, a larger width of the metal-melting chamber is likely to lead to a larger area of the bottom face of the metal-melting chamber, which may disadvantageously result in scattering of unnecessary matter all over the bottom face of the metal-melting chamber, which takes a lot of labor.

In view of the above, the angle α of the molten-metal-heating unit 2 is preferably 20 degrees or larger.

On the other hand, with the angle α being larger than 45 degrees, the height of the metal-melting chamber 13 accommodating the molten-metal-heating unit 2 cannot be made smaller, which may lead to the above-discussed disadvantage of deteriorating operation efficiency of the existing facility.

In view of such disadvantage in operation, the angle α is preferably 45 degrees or smaller.

In the embodiment illustrated in FIG. 2, the right and left side walls 13Ds of the vessel 13D for the metal-melting chamber are approximately vertical, and the bottom face section 13Db on the right in the figure is approximately horizontal. On the other hand, the bottom face section 13Db on the left in the figure of the vessel 13D for the metal-melting chamber slopes downward from the left to the right in the figure, like the molten-metal-heating unit 2. The slope angle β of the sloping bottom face section 13Db1 of the bottom 13Db of the vessel 13D for the metal-melting chamber (angle β of depression between the extension 13Dx of the sloping bottom face section 13Db1 and the imaginary horizontal line 13Dy) is preferably approximately the same as the tilt angle α of the molten-metal-heating unit 2. For example, when the tilt angle α of the molten-metal-heating unit 2 is 35 degrees, the slope angle β of the sloping bottom face section 13Db1 is preferably also about 33 to 37 degrees, most preferably 35 degrees. With the tilt angle α and the slope angle β being matched, the molten-metal-heating unit 2 and the sloping bottom face section 13Db1 are approximately parallel to each other, so that the distance X (the distance in the direction perpendicular to the axis 2x of the molten-metal-heating unit 2) between the surface of the molten-metal-heating unit 2 and the bottom 13Db (sloping bottom face section Db1) is generally the same all over. As a result, heat is uniformly transmitted from the molten-metal-heating unit 2 to the molten metal MM flowing through space Y between the molten-metal-heating unit 2 and the sloping bottom face section 13Db1, so that the ingots not completely molten in the ingot-introduction chamber 11 and the return scrap not completely molten in the return-scrap-introduction chamber 12 may be kept from remaining unmolten.

That is, the ingots not completely molten in the ingot-introduction chamber 11 and the return scrap not completely molten in the return-scrap-introduction chamber 12, as they are closer to the molten-metal-heating unit 2 as a heat source, tend to be molten more easily. In particular, the space Y between the surface of the molten-metal-heating unit 2 and the sloping bottom face section 13Db1, wherein the heat from the molten-metal-heating unit 2 hits and is reflected on the sloping bottom face section 13Db1 to return to the molten-metal-heating unit 2, is higher in temperature than in other space (e.g., the space upper right of the molten-metal-heating unit 2 in FIG. 2), and is thus the space wherein the ingots not completely molten in the ingot-introduction chamber 11 and the return scrap not completely molten in the return-scrap-introduction chamber 12 are easier to melt (referred to as an melting-facilitative space Y hereinbelow, meaning that the ingots and the like not completely molten are more easily molten in that space). With the distance X between the surface of the molten-metal-heating unit 2 and the sloping bottom face section 13Db1 being generally the same all over in the axial direction of the molten-metal-heating unit 2, the above-mentioned melting-facilitative space Y is generally uniform in temperature all over, hardly resulting in areas wherein the ingots not completely molten in the ingot-introduction chamber 11 and the return scrap not completely molten in the return-scrap-introduction chamber 12 are either easier or harder to melt. In this way, the ingots not completely molten in the ingot-introduction chamber 11 and the return scrap not completely molten in the return-scrap-introduction chamber 12 are kept from remaining unmolten.

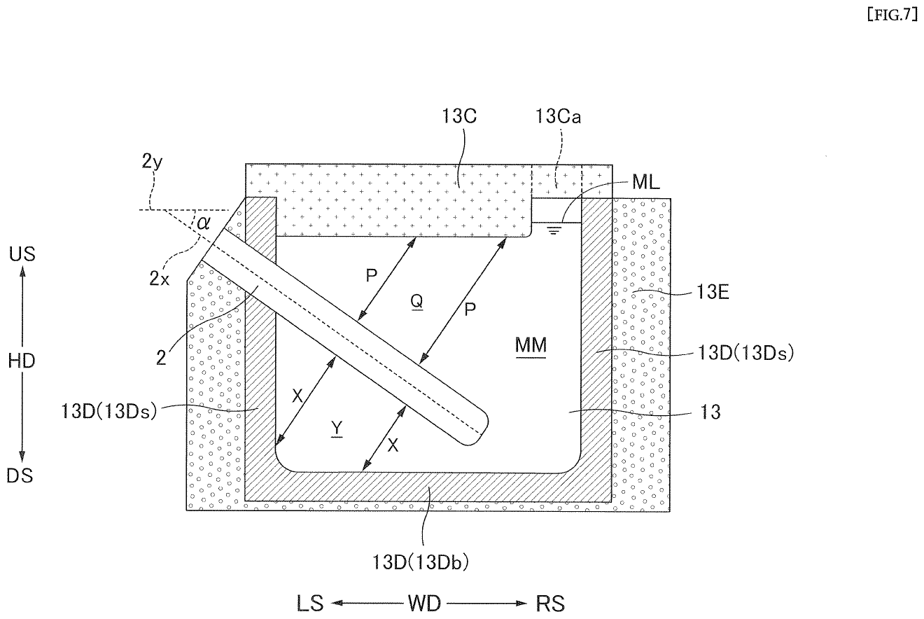

Further, the metal-melting chamber 13 as shown in FIG. 2, compared to the metal-melting chamber 13 with the bottom 13Db not being sloped as shown in FIG. 7, has a shorter distance X from the molten-metal-heating unit 2 to the bottom 13Db below (or to the left side wall 13Ds in FIG. 7, the same is applied hereinbelow). Consequently, the flow speed of the molten metal MM flowing through the melting-facilitative space Y is higher in the metal-melting chamber 13 illustrated in FIG. 2 than in the metal-melting chamber 13 illustrated in FIG. 7. By causing a larger amount of molten metal MM to flow at a higher speed through the melting-facilitative space Y, a larger amount of molten metal MM is brought into contact with the surface of the molten-metal-heating unit 2 facing the melting-facilitative space Y, which facilitates transfer of heat from the molten metal-heating unit 2 to the molten metal MM. In this way, in the molten metal MM the ingots not completely molten in the ingot-introduction chamber 11 and the return scrap not completely molten in the return-scrap-introduction chamber 12 may be molten at a still higher speed.

Further, with the bottom 13Db of the metal-melting chamber 13 being sloped, the flow speed of the molten metal MM through the melting-facilitative space Y may be higher, so that a larger amount of molten metal MM is brought into contact with the surface of the molten-metal-heating unit 2 facing the melting-facilitative space Y. As a result, heat from the molten-metal-heating unit 2 is more easily transferred to the molten metal MM, and the time required for raising temperature of the molten metal around the metal material, such as ingots or return scrap, introduced into the molten metal, which temporarily lowers the temperature of the molten metal therearound, may be shortened, resulting in quick raising of the temperature of the molten metal MM. According to this first embodiment or the like of the metal-melting chamber 13, a lowered temperature of the molten metal MM around the objects may be raised in a short time, so that the transfer of heat of the molten metal MM to the objects may be facilitated.

When the vessel 13D for the metal-melting chamber is provided with the sloping bottom face section 13Db1, the distance X from the surface of the molten-metal-heating unit 2 to the sloping bottom face section 13Db1 as shown in FIG. 2 is preferably 7 to 13 cm, more preferably 10 to 11 cm. With the distance X less than 7 cm, the melting-facilitative space Y is too small, which leads to too small an amount of the molten metal MM flowing through the melting-facilitative space Y per unit time. As a result, the melting speed in the metal-melting chamber 13 of the ingots not completely molten in the ingot-introduction chamber 11 and the return scrap not completely molten in the return-scrap-introduction chamber 12 may be slow. With the distance X larger than 13 cm, the melting-facilitative space Y is too large, which leads to difficulties in raising temperature of the melting-facilitative space Y. As a result, the melting speed in the metal-melting chamber 13 of the ingots not completely molten in the ingot-introduction chamber 11 and the return scrap not completely molten in the return-scrap-introduction chamber 12 may be slow. Further, the flow speed of the molten metal MM through the melting-facilitative space Y is not high enough, resulting in less amount of molten metal MM brought into contact with the surface of the molten-metal-heating unit 2 facing the melting-facilitative space Y. In this way, the heat from the molten-metal-heating unit 2 is harder to be transferred to the molten metal MM and the temperature of the molten metal MM may not be raised.

Note that, to be precise, the distance from the molten-metal-heating unit 2 to the bottom 13Db below in the comparative example shown in FIG. 7 varies widely. In this case, the distance X refers to the average distance from the molten metal-heating unit 2 to the bottom 13Db below.

As shown in FIG. 2, the bottom 13Db of the vessel 13D for the metal-melting chamber has a laterally-extending bottom face section 13Db2 laterally extending from the lower end of the sloping bottom face section 13Db1. This laterally-extending bottom face section 13Db2 extends approximately horizontally and laterally from the lower end of the sloping bottom face section 13Db1.

When the air filling the space AR between the lid 13C of the metal-melting chamber 13 and the melt surface ML of the molten metal MM is brought into contact with the molten metal MM, oxides are generated in the molten metal MM. Further, since ingots and return scrap contain heavy metal, such as copper, iron, and zinc, melting of ingots or return scrap results in by-products. Such oxides and by-products (collectively referred to as the unnecessary matter hereinbelow, in the sense of substance not necessary) are gradually accumulated on the bottom 13Db of the metal-melting chamber 13 by gravity with the lapse of time.

By providing the bottom 13Db of the metal-melting chamber 13 with the sloping bottom face section 13Db1 as shown in FIG. 2, the unnecessary matter fell onto the sloping bottom face section 13Db1 tumbles along the slope of the sloping bottom face section 13Db1 and accumulates on the laterally-extending bottom face section 13Db2. That is, the unnecessary matter will not be scattered all over the bottom face of the metal-melting chamber 13, but naturally gather onto the laterally-extending bottom face section 13Db2. Accordingly, the unnecessary matter may simply be collected by causing the opening 13Ca in the lid 13C to open, inserting a ladle or the like through the opening 13Ca into the metal-melting chamber 13, and scooping out the unnecessary matter accumulated on the laterally-extending bottom face section 13Db2, which results in increased collection efficiency of the unnecessary matter, compared to the embodiment without the sloping bottom face section 13Db1 as shown in FIG. 7.

It is further preferred, as shown in FIGS. 1 and 2, to provide a further recess (groove 13Db3) in the laterally-extending bottom face section 13Db2. With such a groove 13Db3, the unnecessary matter may easily be collected by bringing the unnecessary matter on the laterally-extending bottom face section 13Db2 into this groove 13Db3, and then inserting the ladle into the interior of the groove 13Db3, and moving the ladle along the direction of extension of the groove 13Db3.

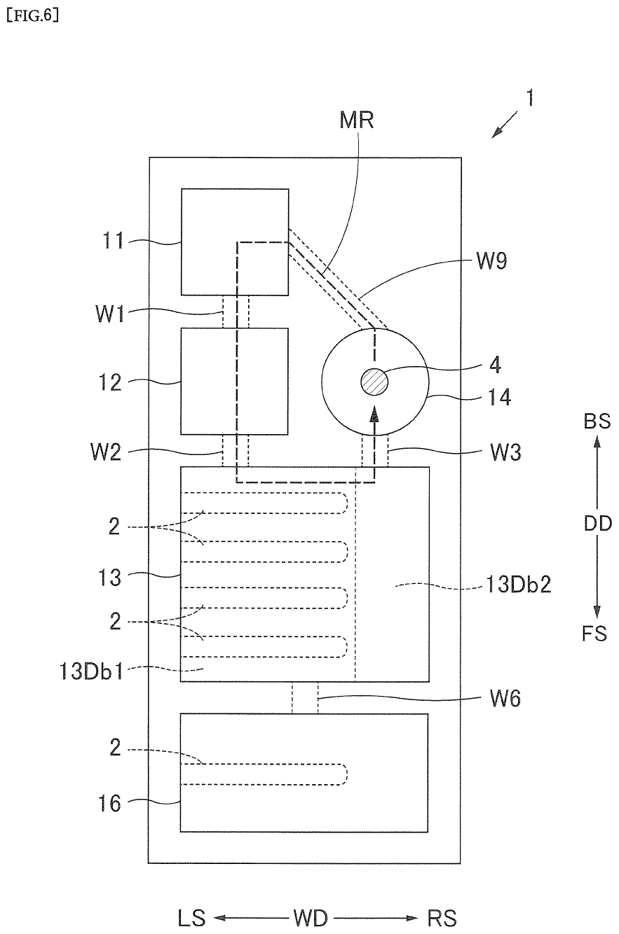

The first embodiment includes the slag-removing chamber 15, which may not necessarily be provided and may be omitted as in the third embodiment shown in FIG. 6, since the slag is not removed very often, for example, once in a month or so. Even without the slag-removing chamber 15, the slag may be removed from the molten metal MM by scooping out the slag with a ladle in the apparatus, such as the ingot-introduction chamber 11, the return-scrap-introduction chamber 12, and the metal-melting chamber 13. The slag, instead of being scooped out with a ladle, may alternatively be removed by spreading flux in powder form for use in melting metal in the above-mentioned apparatus to cause the flux to adsorb the slag to remove.

### Second Embodiment

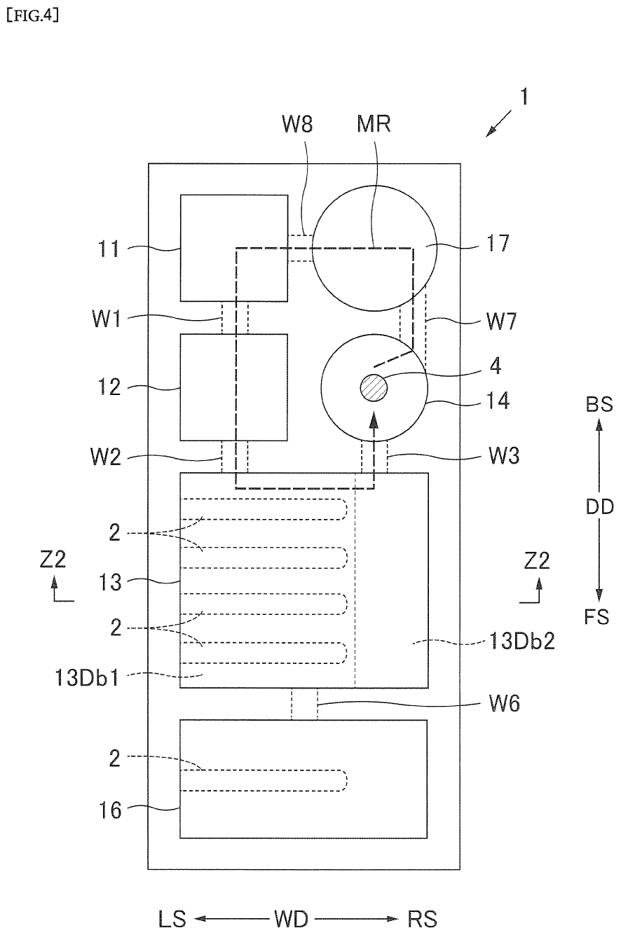

FIG. 4 illustrates a molten metal furnace 1 according to the second embodiment. In the following description, explanations of configurations identical with those of the first embodiment are omitted, and only the different configurations are to be discussed.

The second embodiment is characterized in that the slag-removing chamber 15 is not provided in the subsequent stage to the flow-generating chamber 14 and, instead, scrap-melting chamber 17 for melting scrap material is provided.

Briquette material, which is a kind of scrap material and made by compressing into lumps cutting wastes, machining chips, and the like, generated in processing, contains oil and water, and thus cannot be made into molten metal of high quality, if melted as it is. Scrap material is hard to melt into molten metal in the manner similar to that for ingots or return scrap, and is preferably pretreated by drying or otherwise for removing oil and water contained therein through evaporation.

Further, briquette material has a lower specific gravity and a larger surface area compared to molten metal, and thus easily floats on the surface of the molten metal and is partly prone to oxidization during melting. Similarly, machining chips also have a lower specific gravity and a larger surface area, and thus easily float on the surface of the molten metal and are partly prone to oxidization during melting.

In view of the above, vortex is generated by the flow-generating apparatus 4 in the flow-generating chamber 14, and is caused to flow through seventh transfer line W7 into the scrap-melting chamber 17, wherein scrap material is introduced while the vortex flown therein is maintained. The scrap material introduced into the scrap-melting chamber is drawn down into the bottom face of the vortex in its center. In this way, the scrap material will not float on the surface of the molten metal, and is thus hard to be brought into contact with external air, hardly forming oxides.

The seventh transfer line W7 is preferably arranged in the direction tangent to the vortex generated by the flow-generating apparatus 4. In this way, the vortex may be caused to flow into the scrap-melting chamber 17 without the vortex flow speed being reduced.

The scrap-melting chamber 17 may be in the form of a rectangular box, but the interior space of the scrap-melting chamber 17 is preferably generally in the form of a cylinder or a circular cone in order to maintain the vortex flow flown from the flow-generating chamber 14.

The molten metal MM containing the scrap material molten by the flowing molten metal MM in the scrap-melting chamber 17 and the scrap material not completely molten in the scrap-melting chamber 17, flows from the bottom of the scrap-melting chamber 17 through eighth transfer line W8 into the ingot-introduction chamber 11.

This means that the molten metal MM containing the scrap material not completely molten may flow from the scrap-melting chamber 17 into the ingot-introduction chamber 11. The scrap material not completely molten has a lower specific gravity and a larger surface area, and thus may float on the surface of the molten metal MM in the ingot-introduction chamber 11. In order to keep such scrap material from floating on the molten metal surface, it is preferred to dispose, in the molten metal MM in the ingot-introduction chamber 11, a screen plate for melting metal in the form of a plate provided with a multitude of through holes, as disclosed in Japanese Patent No. 6829491, so that the scrap material having a lower specific gravity is kept from surfacing until it melts to a predetermined size, and held in the region below the screen plate for melting metal.

Though not shown in FIG. 4, if a larger footprint of the molten metal furnace 1 permits, a slag-removing chamber 15 as shown in FIG. 1 may be disposed between the scrap-melting chamber 17 and the ingot-introduction chamber 11 in FIG. 4. With the slag-removing chamber 15, the slag in the molten metal MM may be removed, and clear molten metal MM may result. However, as discussed above, since the slag is not removed very often, the embodiment shown in FIG. 4 is practical. The slag in the molten metal MM may be removed by scooping out the slag with a ladle in the apparatus, such as the ingot-introduction chamber 11, the return-scrap-introduction chamber 12, and the metal-melting chamber 13. Instead of scooping out the slag with a ladle, it is possible to prevent the slag from forming by spreading flux in powder form for use in melting metal in the above-mentioned apparatus.

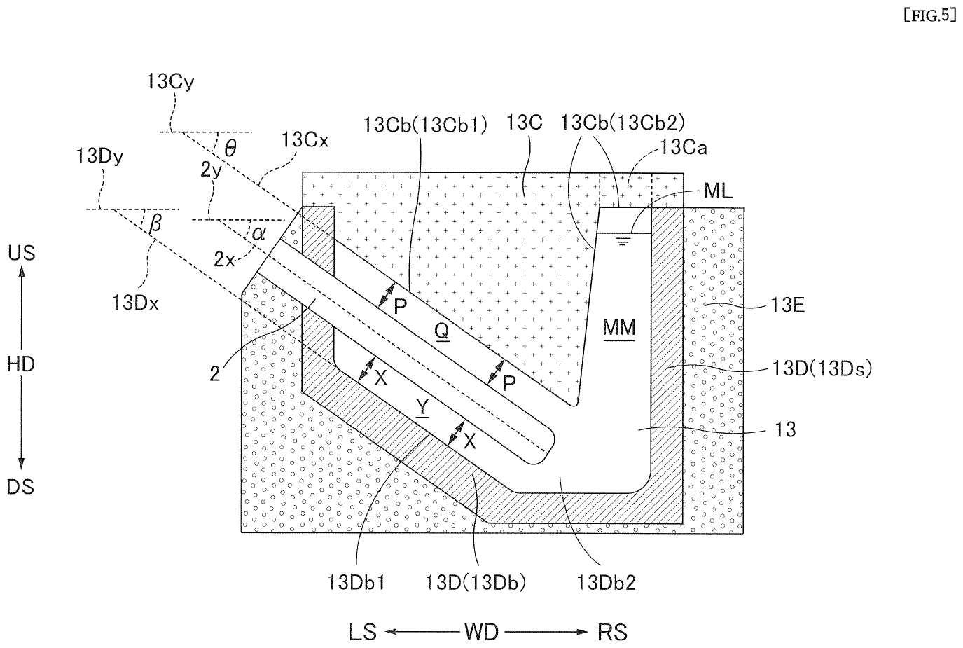

FIG. 5 illustrates a metal-melting chamber 13 according to the second embodiment. The metal-melting chamber 13 shown in FIG. 5 is not limited for use in the molten metal furnace 1 according to the second embodiment, but may be used in other molten metal furnace 1, such as the one according to the first embodiment. Similarly, the metal-melting chamber 13 shown in FIG. 2 is not limited for use in the molten metal furnace 1 according to the first embodiment, but may be used in other molten metal furnace 1, such as the one according to the second embodiment.

The metal-melting chamber 13 of FIG. 5 is similar to the metal-melting chamber 13 of FIG. 2, so that explanation of the configurations in common is omitted, and only the different configurations are to be discussed. The metal-melting chamber 13 of FIG. 5 is characterized in that the lower face 13Cb of the lid 13C, which covers the metal-melting chamber 13, has a slope. Specifically, the lower face 13Cb of the lid 13C located above the molten-metal-heating unit 2 is slanted along the same direction as that of the molten-metal-heating unit 2 with a predetermined gap kept therebetween. This arrangement will now be discussed in detail.

In the embodiment of FIG. 5, part of the lower face 13Cb of the lid 13C, which covers the metal-melting chamber 13, is slanted like the molten-metal-heating unit 2, downward from the left to the right in the figure. In the following, part of the lower face 13Cb of the lid 13C slanted generally in the same direction as that of the molten-metal-heating unit 2 is referred to as a lower face section 13Cb1 slanted in the same direction, whereas part of the lower face 13Cb of the lid 130 slanted generally in a different direction from that of the molten-metal-heating unit 2 is referred to as a lower face section slanted in a different direction or a horizontal lower face section 13Cb2. The tilt angle θ of the lower face section 13Cb1 slanted in the same direction (the angle θ of depression between the imaginary horizontal line 13Cy and extension 13Cx of the lower face section 13Cb1 slanted in the same direction) is preferably approximately identical with the tilt angle α of the molten-metal-heating unit 2. For example, when the tilt angle α of the molten-metal-heating unit 2 is 35 degrees, the tilt angle θ of the lower face section 13Cb1 slanted in the same direction is also preferably about 33 to 37 degrees, most preferably 35 degrees. With the title angles α and θ being matched, the molten-metal-heating unit 2 and the lower face section 13Cb1 of the lid 13C slanted in the same direction are approximately parallel to each other, so that the distance P between the surface of the molten-metal-heating unit 2 and the lower face section 13Cb1 of the lid 13C slanted in the same direction (the distance in the direction perpendicular to the axis 2x of the molten-metal-heating unit 2) is generally the same all over. As a result, heat is uniformly transmitted from the molten-metal-heating unit 2 to the molten metal MM flowing through the space Q between the molten-metal-heating unit 2 and the lower face section 13Cb1 of the lid 13C slanted in the same direction, so that the ingots not completely molten in the ingot-introduction chamber 11, the return scrap not completely molten in the return-scrap-introduction chamber 12, and the scrap material not completely molten in the scrap-melting chamber 17, may be kept from remaining unmolten. That is, the space Q between the molten-metal-heating unit 2 and the lower face section 13Cb1 of the lid 13C slanted in the same direction may be referred to as a melting-facilitative space Q, like the melting-facilitative space Y discussed above. Since the effect of the melting-facilitative space Q, which facilitates melting of the ingots not completely molten in the ingot-introduction chamber 11, the return scrap not completely molten in the return-scrap-introduction chamber 12, and the scrap material not completely molten in the scrap-melting chamber 17, is similar to that of the melting-facilitative space Y, detailed explanation thereof is omitted. The melting-facilitative space Q located above the molten-metal-heating unit 2 is referred to as the upper melting-facilitative space Q, whereas the melting-facilitative space Y located below the molten-metal-heating unit 2 is referred to as the lower melting-facilitative space Y.

When the lid 13C is provided with the lower face section 13Cb1 slanted in the same direction as shown in FIG. 5, the distance P from the surface of the molten-metal-heating unit 2 to the lower face section 13Cb1 slanted in the same direction is preferably 7 to 13 cm, more preferably 10 to 11 cm. With the distance P less than 7 cm, the melting-facilitative space Q is too small, which leads to too small an amount of the molten metal MM flowing through the melting-facilitative space Q per unit time. As a result, the melting speed in the metal-melting chamber 13 of the ingots not completely molten in the ingot-introduction chamber 11, the return scrap not completely molten in the return-scrap-introduction chamber 12, and the scrap material not completely molten in the scrap-melting chamber 17, may be slow. With the distance P larger than 13 cm, the melting-facilitative space Q is too large, which leads to difficulties in raising temperature of the melting-facilitative space Q. As a result, the melting speed in the metal-melting chamber 13 of the ingots not completely molten in the ingot-introduction chamber 11, the return scrap not completely molten in the return-scrap-introduction chamber 12, and the scrap material not completely molten in the scrap-melting chamber 17, may be slow. Further, the flow speed of the molten metal MM through the melting-facilitative space Q is not high enough, resulting in less amount of molten metal MM brought into contact with the surface of the molten-metal-heating unit 2 facing the melting-facilitative space Q. In this way, the heat from the molten-metal-heating unit 2 is harder to be transferred to the molten metal MM and the temperature of the molten metal MM may not be raised.

### Comparative Example

FIG. 7 illustrates a metal-melting chamber 13 according to a comparative example. This comparative example in FIG. 7 is illustrated for comparison with the embodiments shown in FIGS. 2 and 5 to discuss the effects from the configurations thereof, and does not represent a conventionally-known metal-melting chamber 13.

### INDUSTRIAL APPLICABILITY

The molten metal may be aluminum or aluminum alloys, or even other molten metal MM.

Note that the technical scope of the present invention is not limited to the above-discussed embodiments, and various modifications and alterations may be made to the invention without departing from the spirit thereof. For example, the molten metal furnace 1 according to the present invention may be applicable to a melting and holding furnace, a melting furnace, a holding furnace, a furnace for low pressure casting, or the like.

### DESCRIPTION OF REFERENCE NUMERALS

1: molten metal furnace
2: molten-metal-heating unit
2x: axis of molten-metal-heating unit
2y: imaginary horizontal line (for molten-metal-heating unit)
4: flow-generating apparatus
4A: motor
4Aa: rotary shaft (of motor)
4B: rotary shaft
4Ba: driven shaft
4Bb: output shaft
4C: impeller
4Ga: gear (attached to output shaft)
4Gb: gear (attached to rotary shaft of motor)
4V: belt
11: ingot-introduction chamber
12: return-scrap-introduction chamber
13: metal-melting chamber
13C: lid
13Ca: opening (in lid)
13Cb: lower face of lid
13Cb1: lower face section slanted in the same direction
13Cb2: lower face section slanted in a different direction or horizontal lower face section
13Cx: extension of lower face section slanted in the same direction
13Cy: imaginary horizontal line (for lower face section slanted in the same direction)
13D: vessel for metal-melting chamber
13Db: bottom (of vessel for metal-melting chamber)
13Db1: sloping bottom face section
13Db2: laterally-extending bottom face section
13Db3: groove
13Dx: extension of sloping bottom face section
13Ds: side wall (of vessel for metal-melting chamber)
13Dy: imaginary horizontal line (for sloping bottom face section)
13E: heat insulator
14: flow-generating chamber
14A: supply port of molten metal
14B: discharge port of molten metal
14C: lid (of flow-generating chamber)
14D: vessel (of flow-generating chamber)
15: slag-removing chamber
16: melt-tapping chamber
17: scrap-melting chamber
AR: space between lower face of lid and melt surface of molten metal
ML: melt surface
MM: molten metal
MR: direction of circulating flow of molten metal
OT: direction of rotation (of impeller)
P: distance between upper surface of molten-metal-heating unit and lower face section of lid slanted in same direction
Q: melting-facilitative space (upper melting-facilitative space)
W1: first transfer line
W2: second transfer line
W3: third transfer line
W4: fourth transfer line
W5: fifth transfer line
W6: sixth transfer line
W7: seventh transfer line
W8: eighth transfer line
W9: ninth transfer line
X: distance between lower surface of molten-metal-heating unit and sloping bottom face section
Y: melting-facilitative space (lower melting-facilitative space)
α: tilt angle of molten-metal-heating unit
β: tilt angle of sloping bottom face section
θ: tilt angle of lower face section slanted in same direction
DD: depth direction
FS: front side
BS: back side
HD: height direction
DS: downside (lower side)
US: upper side (topside)
WD: width direction
LS: left side
RS: right side

1. A molten metal furnace comprising a metal-melting chamber for accommodating molten metal therein and performing at least one of melting metal material in flowing melt of molten metal and raising temperature of molten metal,
wherein an elongate molten-metal-heating unit for heating the molten metal is provided inside the metal-melting chamber,
wherein the molten-metal-heating unit is provided extending from a side wall toward a lower part of the metal-melting chamber, and
wherein a bottom face of the metal-melting chamber located below the molten-metal-heating unit is slanted along a same direction as that of the molten-metal-heating unit with a predetermined gap kept therebetween.

2. The molten metal furnace according to claim 1, wherein the bottom face of the metal-melting chamber has:
a sloping bottom face section located below and slanted approximately parallel to the molten-metal-heating unit, and
a laterally-extending bottom face section extending laterally from a lower end of the sloping bottom face section, and
wherein an unnecessary-matter-accumulated area in which unnecessary matter contained in the molten metal is accumulated is provided on the laterally-extending bottom face section.

3. The molten metal furnace according to claim 1,
wherein a lid covering the metal-melting chamber is provided in an upper part of the metal-melting chamber,
wherein the lid of the metal-melting chamber located above the molten-metal-heating unit is slanted along a same direction as that of the molten-metal-heating unit with a predetermined gap kept therebetween.

4. A molten metal furnace comprising a metal-melting chamber for accommodating molten metal therein and performing at least one of melting metal material in flowing melt of molten metal and raising temperature of molten metal,
wherein an elongate molten-metal-heating unit for heating the molten metal is provided inside the metal-melting chamber,
wherein the molten-metal-heating unit is provided extending from a side wall toward a lower part of the metal-melting chamber,
wherein a lid covering the metal-melting chamber is provided in an upper part of the metal-melting chamber, and
wherein the lid of the metal-melting chamber located above the molten-metal-heating unit is slanted along a same direction as that of the molten-metal-heating unit with a predetermined gap kept therebetween.
